(19) United States
(12) Patent Application Publication
(10) Pub. No.: US 2024/0333367 A1
(43) Pub. Date: Oct. 3, 2024

(54) CHANNEL ESTIMATION, HYBRID PRECODING, AND SCHEDULING OF MULTI-USER MIMO

(71) Applicant: Samsung Electronics Co., Ltd., Suwon-si (KR)

(72) Inventors: Ahmad AlAmmouri, Richardson, TX (US); Rajesh Kumar Mishra, Dallas, TX (US); Jianhua Mo, Allen, TX (US); Young Han Nam, Plano, TX (US)

(21) Appl. No.: 18/610,187

(22) Filed: Mar. 19, 2024

Related U.S. Application Data
(60) Provisional application No. 63/456,732, filed on Apr. 3, 2023.

(51) Int. Cl. H04B 7/06; H04B 7/0426; H04B 7/0452; H04L 5/00

(52) U.S. Cl. CPC H04B 7/06952; H04B 7/0426; H04B 7/0452; H04L 5/0051

(57) ABSTRACT

A method includes selecting a set of orthogonal beams to be used for SRS full-channel reconstruction in a multi-user multiple-input multiple-output (MU-MIMO) system. The method also includes generating an analog precoding matrix for hybrid analog-digital precoding in the MU-MIMO system. The method further includes communicating with multiple users using the MU-MIMO system and the analog precoding matrix.

### CROSS-REFERENCE TO RELATED APPLICATIONS AND CLAIM OF PRIORITY

The present application claims priority to U.S. Provisional Patent Application Ser. No. 63/456,732 filed on Apr. 3, 2023. The content of the above-identified patent document is incorporated herein by reference.

### TECHNICAL FIELD

The present disclosure relates generally to wireless communication systems and, more specifically, the present disclosure relates to a method and apparatus for channel estimation, hybrid precoding, and scheduling in a multi-user multiple-input multiple-output (MU-MIMO) system.

### BACKGROUND

As wireless communication standards continue to evolve, it is expected that 5G-advanced or 6G base stations will support high order multi-user multiple-input multiple-output (MU-MIMO), for example, 16-layer or 32-layer MU-MIMO. Higher order MU-MIMO can provide higher spectral efficiency and higher beamforming gain for better power efficiency. As the number of MU-MIMO layers increases, the computational complexity increases significantly.

### SUMMARY

The present disclosure relates to wireless communication systems and, more specifically, the present disclosure relates to a method and apparatus for channel estimation, hybrid precoding, and scheduling in a multi-user MIMO system.

In one embodiment, a method includes selecting a set of orthogonal beams to be used for SRS full-channel reconstruction in a multi-user multiple-input multiple-output (MU-MIMO) system. The method also includes generating an analog precoding matrix for hybrid analog-digital precoding in the MU-MIMO system. The method further includes communicating with multiple users using the MU-MIMO system and the analog precoding matrix.

In another embodiment, a device includes a transceiver and a processor operably connected to the transceiver. The processor is configured to: select a set of orthogonal beams to be used for SRS full-channel reconstruction in a MU-MIMO system; generate an analog precoding matrix for hybrid analog-digital precoding in the MU-MIMO system; and communicate with multiple users using the MU-MIMO system and the analog precoding matrix.

In yet another embodiment, a non-transitory computer readable medium includes program code that, when executed by a processor of a device, causes the device to: select a set of orthogonal beams to be used for SRS full-channel reconstruction in a MU-MIMO system; generate an analog precoding matrix for hybrid analog-digital precoding in the MU-MIMO system; and communicate with multiple users using the MU-MIMO system and the analog precoding matrix.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example beamforming architecture according to embodiments of the present disclosure;

FIG. 5 illustrates an example architecture for an antenna panel of a base station according to embodiments of the present disclosure;

FIG. 6 illustrates an example base station configured for hybrid beamforming according to embodiments of the present disclosure;

FIG. 7 illustrates an example base station configured for SRS reception and processing in hybrid systems according to embodiments of the present disclosure;

FIG. 8 illustrates a structure of an example neural network for determining an analog beamformer according to embodiments of the present disclosure;

FIGS. 9 and 10 illustrate example processes for joint selection and precoding design according to embodiments of the present disclosure; and

FIG. 11 illustrates a method for channel estimation, hybrid precoding, and scheduling in a multi-user MIMO system according to embodiments of the present disclosure.

### DETAILED DESCRIPTION

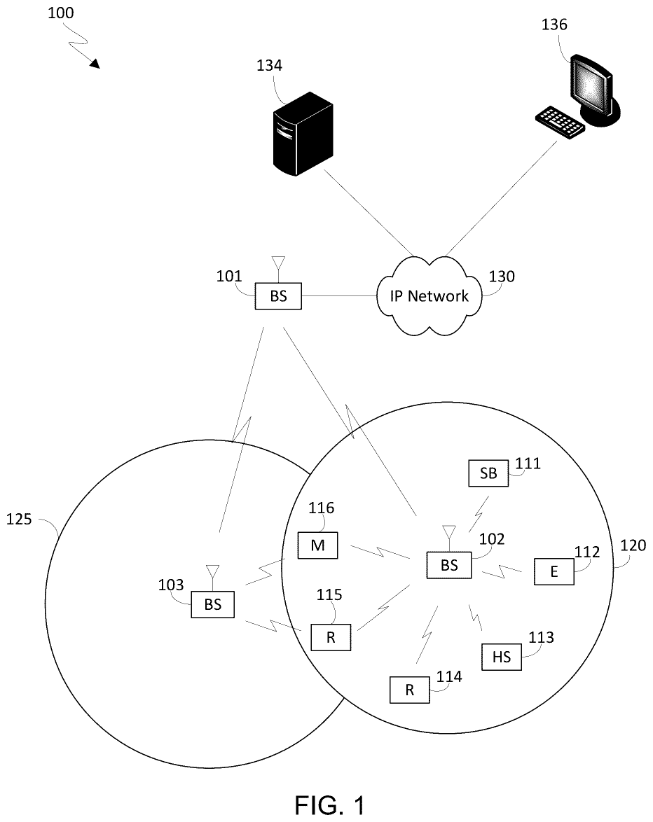

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNodeB or gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

In some embodiments, the network 130 facilitates communications between at least one server 134 and various client devices, such as a client device 136. The server 134 includes any suitable computing or processing device that can provide computing services for one or more client devices. The server 134 could, for example, include one or more processing devices, one or more memories storing instructions and data, and one or more network interfaces facilitating communication over the network 130.

The client device 136 represents any suitable computing or processing device that interacts with at least one server or other computing device(s) over the network 130. In this example, the client device is represented as a desktop computer, but other examples of client devices can include a mobile telephone, laptop computer, or tablet computer. However, any other or additional client devices could be used in the wireless network 100.

In this example, client devices can communicate indirectly with the network 130. For example, some client devices can communicate via one or more base stations, such as cellular base stations or eNodeBs. Also, client devices can communicate via one or more wireless access points (not shown), such as IEEE 802.11 wireless access points. Note that these are for illustration only and that each client device 136 could communicate directly with the network 130 or indirectly with the network 130 via any suitable intermediate device(s) or network(s).

As described in more detail below, a computing device, such as the server 134 or the client device 136, may perform operations in connection with beam management. For example, the server 134 or the client device 136 may perform operations in connection with channel estimation, hybrid precoding, and scheduling in a multi-user MIMO system as discussed herein.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

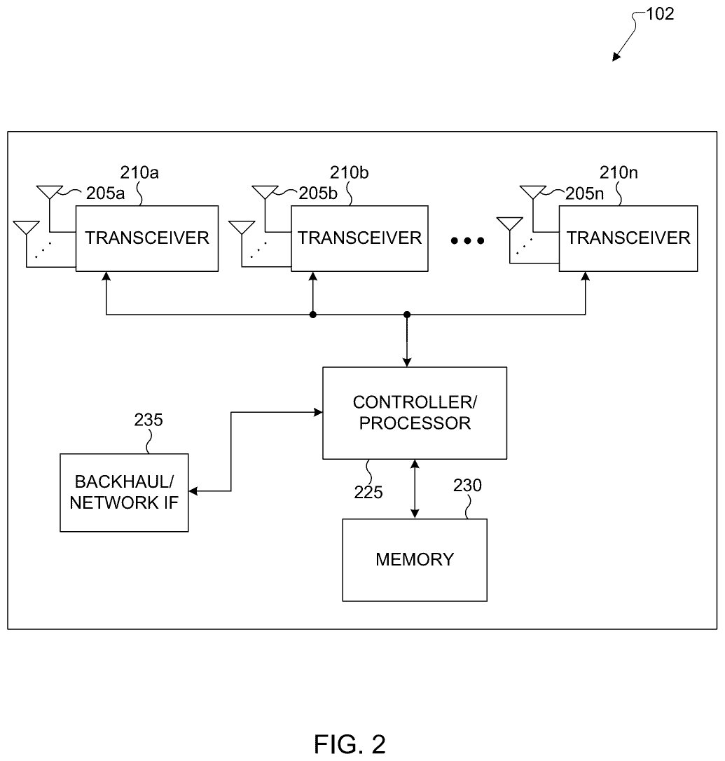

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support channel estimation, hybrid precoding, and scheduling in a multi-user MIMO system as discussed herein. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

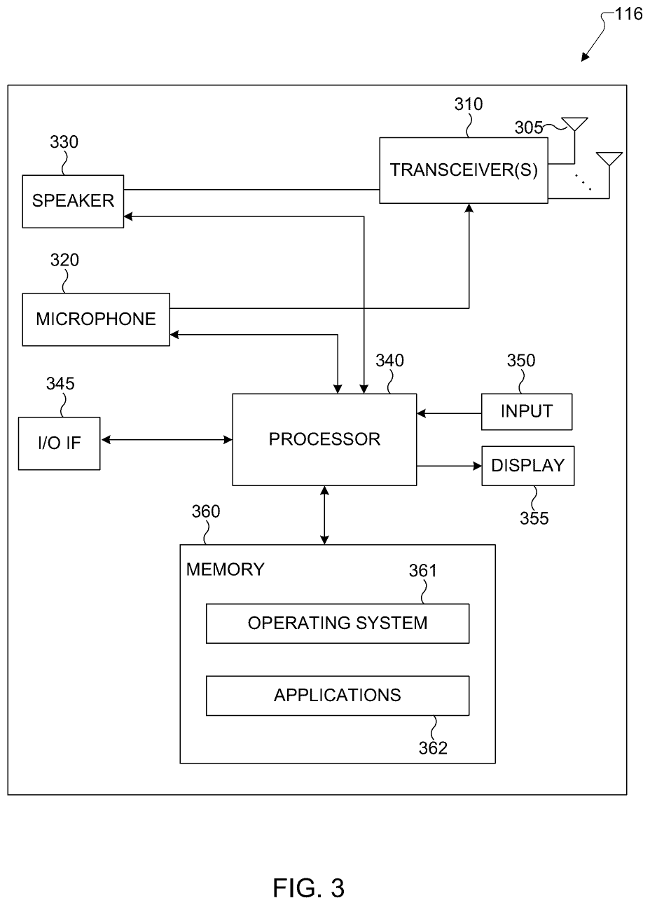

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for channel estimation, hybrid precoding, and scheduling in a multi-user MIMO system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 (which includes for example, a touchscreen, keypad, etc.) and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

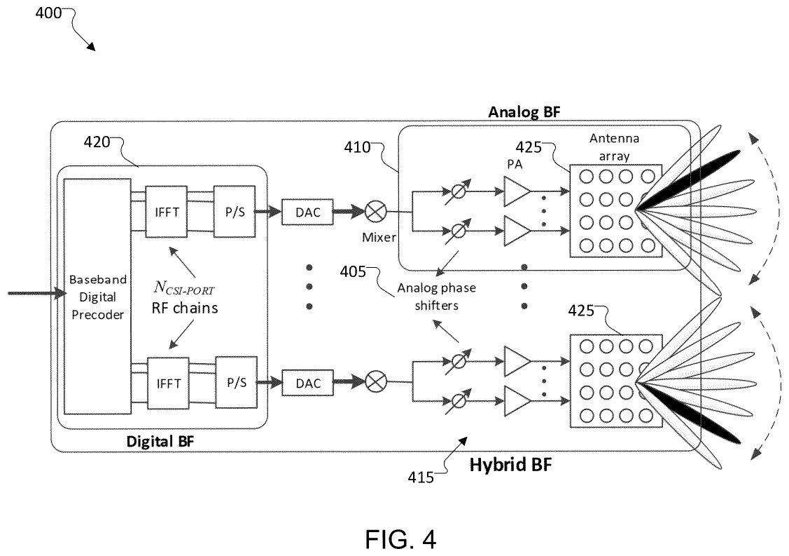

FIG. 4 illustrates an example beamforming architecture 400 according to embodiments of the present disclosure. The embodiment of the beamforming architecture 400 illustrated in FIG. 4 is for illustration only. FIG. 4 does not limit the scope of this disclosure to any particular implementation of the beamforming architecture 400. In certain embodiments, one or more of gNB 102 or UE 116 can include the beamforming architecture 400. For example, one or more of antenna 205 and its associated systems or antenna 305 and its associated systems can be configured the same as or similar to the beamforming architecture 400.

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports-which can correspond to the number of digitally precoded ports-tends to be limited due to hardware constraints (such as the feasibility to install a large number of analog-to-digital converts/digital-to-analog converts (ADCs/DACs at mmWave frequencies)).

In the example shown in FIG. 4, the beamforming architecture 400 includes analog phase shifters 405, an analog beamformer (BF) 410, a hybrid BF 415, a digital BF 420, and one or more antenna arrays 425. In this case, one CSI-RS port is mapped onto a large number of antenna elements in antenna arrays 425, which can be controlled by the bank of analog phase shifters 405. One CSI-RS port can then correspond to one sub-array which produces a narrow analog beam through analog beamforming by analog BF 410. The analog beam can be configured to sweep across a wider range of angles by varying the phase shifter bank 405 across symbols or subframes. The number of sub-arrays (equal to the number of RF chains) is the same as the number of CSI-RS ports NCSI-PORT. The digital BF 420 performs a linear combination across NCSI-PORT analog beams to further increase precoding gain. While analog beams are wideband (hence not frequency-selective), digital precoding can be varied across frequency sub-bands or resource blocks.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

Additionally, the beamforming architecture 400 is also applicable to higher frequency bands such as >52.6 GHz (also termed the FR4). In this case, the beamforming architecture 400 can employ only analog beams. Due to the O2 absorption loss around 60 GHz frequency (˜10 decibels (dB) additional loss @100 m distance), larger numbers of and sharper analog beams (hence larger number of radiators in the array) will be needed to compensate for the additional path loss.

As discussed above, 5G-advanced and 6G base stations are expected to support high order MU-MIMO, for example, 16-layer or 32-layer MU-MIMO. High order MU-MIMO can provide higher spectral efficiency and higher beamforming gain for better power efficiency. As the number of MU-MIMO layers increases, the computational complexity increases significantly.

### Introduction to Hybrid Precoding.

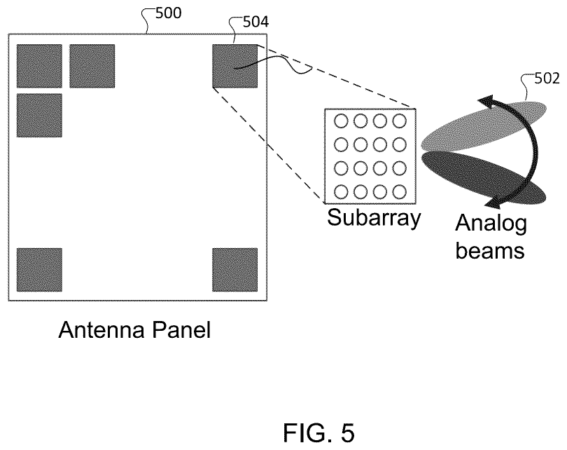

The use of hybrid beamforming in MU-MIMO implementations is gaining more momentum, with recent interest in the upper-mid band (7 to 24 GHz) carriers, which allow for a very large number of antennas (e.g., 2048 antennas). However, having a large number of antennas renders a fully digital architecture impractical due to high power consumption, and a hybrid architecture becomes inevitable. In the hybrid scheme, a fewer number of digital chains (e.g., 256) drive the full antenna arrays through a sub-array structure, where each digital chain is connected to a single sub-array with a number of antenna elements (e.g., 16), such as shown in FIG. 5.

FIG. 5 illustrates an example architecture for an antenna panel 500 of the BS 102 according to various embodiments of the present disclosure. As shown in FIG. 5, the antenna panel 500 includes multiple (e.g., 256) digital chains, each capable of forming tunable analog beams 502 across a sub-array 504. In some embodiments, each sub-array 504 is a sixteen element sub-array, meaning that each sub-array 504 includes sixteen antenna elements. However, this is merely one example; other sub-array sizes are possible and within the scope of this disclosure. In general, an antenna panel can include N_{T} antenna elements, which are partitioned into sub-arrays of an equal number of elements, such as N_{A} antenna elements. The total number of sub-arrays is denoted as N_{D}, and N_{D}=N_{T}/N_{A}.

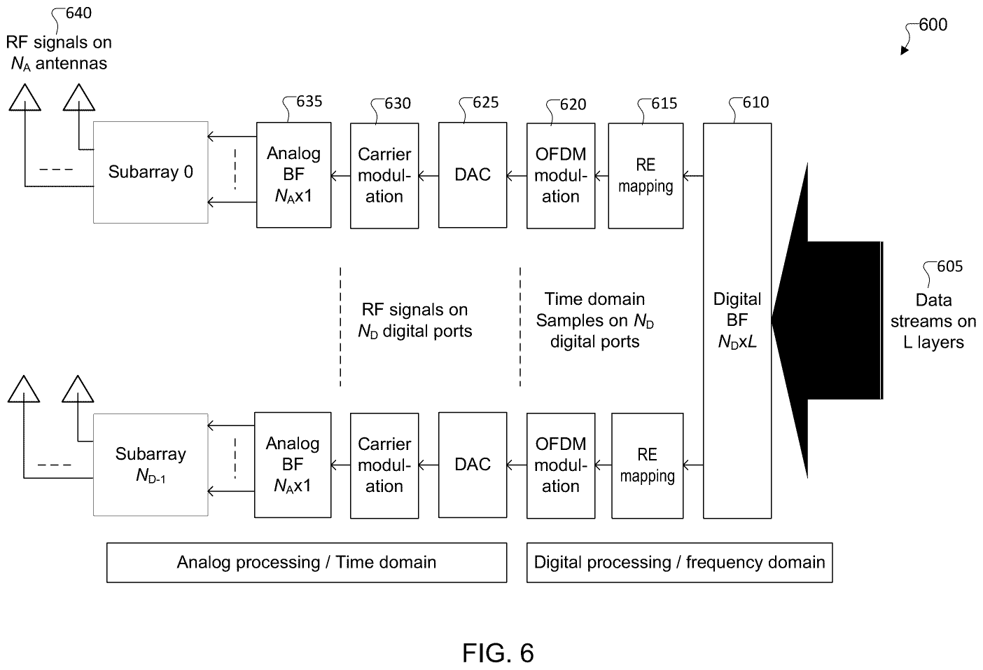

FIG. 6 illustrates an example base station 600 configured for hybrid beamforming according to various embodiments of the present disclosure. The base station 600 can represent, for example, the BS 102 of FIG. 1. In some embodiments, the base station 600 includes a RF frontend and baseband implementation, and is equipped with an antenna panel such as described in conjunction with FIG. 5.

As shown in FIG. 6, starting from the right, L data streams 605, or L sequences of modulation symbols, are provided to a digital beamformer (BF) 610, which converts the L data streams 605 to Np data streams, with multiplying a digital precoder pₖ^{D}, whose dimension is N_{D}×L, on the resource elements comprising PRB bundle k, wherein k=0, . . . , N_{PRB-bundles}−1, and N_{PRB-bundles} is the total number of PRB bundles that the data stream is mapped to.

The modulation symbols on each of Np data streams are then mapped to resource elements (REs) 615, go through OFDM modulation 620, and are finally converted to time domain samples. These time domain samples are converted to analog via a digital-to-analog converter 625, go through carrier modulation 630, and an analog signal is obtained for each of these N_{D} paths.

Then, the analog signal goes through an analog BF block 635, where an analog precoder p^{A} of size N_{A}×1 is applied for path d, where d=0, . . . , N_{D}−1. Applying analog BFs for the signals on all the N_{D} paths, the RF signals 640 on N_{T}=N_{A}×N_{D} antenna elements are constructed.

However, to efficiently design the analog precoders, the base station 600 needs to know the full-element channel per each UE (e.g., the UEs 111-116). As used herein, the full-element channel means the channel per analog port. To this end, a sounding reference signal (SRS) can be used to obtain the full-element channel, as described below.

### SRS-Based Channel Reconstruction:

SRS is transmitted by the UE according to configurations provided by the base station. For the specific case of channel reconstruction, the process is relatively simple for the fully digital system, but a bit more involved for hybrid systems. To illustrate the operation in a hybrid system, consider the following example. Assume that a base station includes N_{T} antennas and N_{D} digital ports. Hence, every digital port is driving a sub-array with

$${N}_{A} := \frac{{N}_{T}}{{N}_{D}}$$

elements, where each element is controlled through a phase shifter. In total, each sub-array can have N_{A} orthogonal beams, denoted by pᵢ^{A}∈ [symbol] ^{N}^{_{A}}^{×1}, i∈[1, N_{A}]. Assuming a single-antenna UE for simplicity, the received digital signal over the k^{th} subcarrier is given by the following:

$${y}_{k , i} = {{P}_{T}^{i} ( I ⊗ {p}_{i}^{A} )}^{H} {h}_{k} + {n}_{k} ,$$

where y_{k,n}∈ [symbol] ^{N}^{_{D}}^{×1} is the received digital signals, P_{T}ⁱ is the UE TX power over the i^{th} RX beam, pᵢ^{A}∈ [symbol] ^{N}^{_{A}}^{×1} is the analog beam per sub-array, i is the analog beam index, ⊗ is the Kronecker product, I∈ [symbol] ^{N}^{_{D}}^{×N}^{_{D}} is an identity matrix, hₖ∈ [symbol] ^{N}^{_{T}}^{×1} is the channel between a UE and the BS over the k^{th} subcarrier, and nₖ is the thermal noise over the k^{th} subcarrier. In this case, (I⊗pᵢ^{A})∈ [symbol] ^{N}^{_{T}}^{×N}^{_{D}} is a projection matrix.

The full channel estimate is obtained through the different analog beams as shown in the following equation:

$${\tilde{h}}_{k} = {\sum }_{i ∈ [ 1 , {N}_{A} ]} ( I ⊗ {p}_{i}^{A} ) {y}_{k , i} .$$

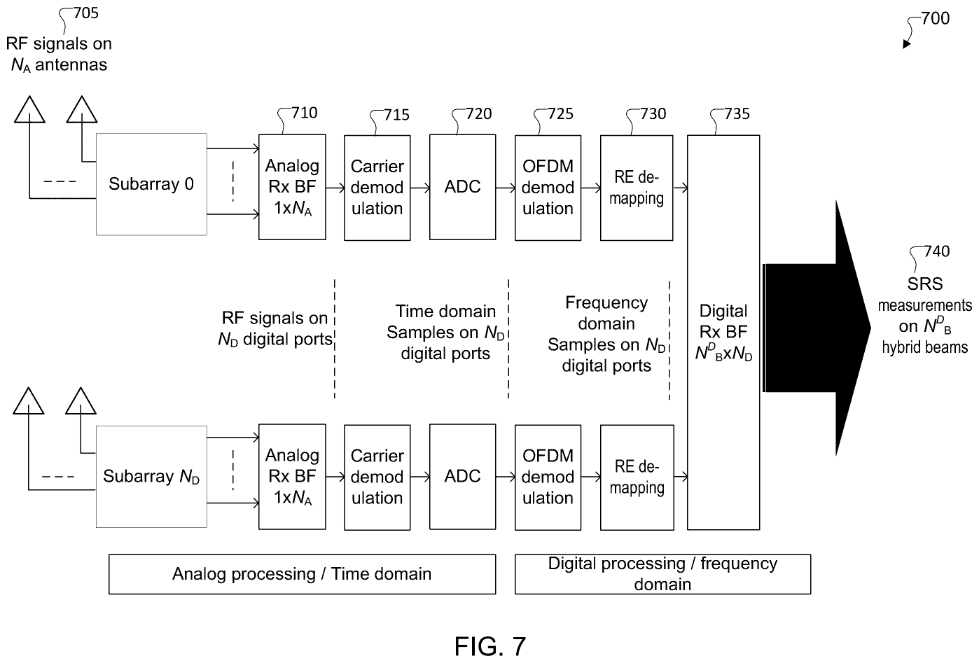

In the noiseless case with equal UE Tx power across analog beams, if one combines the measurements from N_{A} orthogonal beams, then the full-element channel can be recovered, i.e., hₖ=\tilde{h}ₖ. The process of SRS reception in hybrid systems is shown in FIG. 7.

FIG. 7 illustrates an example base station 700 configured for SRS reception and processing in hybrid systems according to various embodiments of the present disclosure. As shown in FIG. 7, the base station 700 is configured similar to the base station 600. In one aspect of operation, the base station 700 receives RF signals 705 on N_{T}=N_{A}×N_{D} antenna elements. The RF signals 705 are processed in an analog Rx BF block 710, go through carrier demodulation 715, are converted to digital via an analog-to-digital converter 720, and go through OFDM demodulation 725, RE demapping 730, and digital RX beamforming 735. The base station 700 then generates the SRS measurements 740 on the hybrid beams.

### Hybrid Analog and Digital Precoding.

After the full-element channel is reconstructed, the next step is to design the analog precoder given the reconstructed channel. Recall that there are N_{D} transceivers and N_{T} antennas in the whole antenna panel 500 in FIG. 5. The antenna panel 500 transmits L layers of data to N_{UE} UEs, each equipped with N_{Ant}^{UE} antennas simultaneously. The received signals at the N_{UE} can be expressed as:

$$y = {HF}_{RF} {F}_{BB} x + n ,$$

where:
F_{RF}∈ [symbol] ^{N}^{_{T}}^{×N}^{_{D}} is the analog precoding,
F_{BB}∈ [symbol] ^{N}^{_{D}}^{×L} is the digital precoding,
H∈ [symbol] ^{N}^{_{UE}}^{×N}^{_{Ant}}^{^{UE}}^{×N}^{_{T}} is the channel,
x∈C^{L×1} is the symbol transmitted by the BS,
y∈ [symbol] ^{N}^{_{UE}}^{×N}^{_{Ant}}^{^{UE}}^{×1} is the symbols received by the UEs, and
n∈ [symbol] ^{N}^{_{UE}}^{N}^{_{Ant}}^{^{UE}}^{×1} is the noise.

The analog precoder F_{RF} is a block-diagonal matrix, such as the following:

$${F}_{RF} = [ \begin{matrix}{f}_{RF , 1} & 0 & … & 0 \\ 0 & {f}_{RF , 2} & … & 0 \\ ⋮ & ⋮ & ⋱ & 0 \\ 0 & 0 & … & {f}_{RF , {N}_{TRX}}\end{matrix} ] ,$$

where f_{RF,i}∈ [symbol] ^{N}^{_{Anti}}^{×1} is the analog precoding of the i-th digital sub-array.

In the SRS channel reconstruction process described above, it is necessary to first design the set of vectors (i.e., beams) to be used for channel reconstruction, which can be denoted by pᵢ^{A}∈ [symbol] ^{N}^{_{A}}^{×1}, i∈[1, N_{A}]. Secondly, after the reconstructed channel is obtained, it is necessary to design the hybrid precoders.

To address these and other issues, this disclosure provides systems and methods for channel estimation, hybrid precoding, and scheduling in a multi-user MIMO system. As described in greater detail below, the disclosed embodiments provide a method for designing a set of beams to be used for SRS full-channel reconstruction. The set could be common across different sites or site-specific. The disclosed embodiments also provide a low-complexity method for designing hybrid precoding, where the analog beamforming is common across different sub-arrays. In addition, the disclosed embodiments provide for joint hybrid precoding and scheduling, where the analog beamforming is iteratively optimized based on the set of scheduled users.

Some of the embodiments discussed below are described in the context of MU-MIMO systems operating in the upper-mid band (7 to 24 GHz). Of course, these are merely examples. It will be understood that the principles of this disclosure may be implemented in any number of other types of systems with other frequency bands.

### Choice of the SRS Basis Vectors.

As discussed above, the BS can select a set of orthogonal beams to be used for SRS full-channel reconstruction. In some embodiments, a set of basis vectors can be used as the analog beamformer. Examples of the set of basis vectors include normal discrete Fourier transform (DFT), rotated DFT, best single beam, “cell specific,” eigenvalue decomposition (EVD), modified eigenvalue decomposition, and artificial intelligence/machine learning (AI/ML). These different types of basis vectors are explained in greater detail, along with the methodologies to obtain them and their applications.

Normal DFT: A normal DFT basis that produces the DFT vectors based on the size of the antenna array along the elevation and the horizontal direction.

Assume that the sub-array is of the size n₁×n₂, where N_{A}=n₁n₂. Then two pairs of DFT matrices of sizes n₁ and n₂ are obtained, and the final DFT matrix is given by the Kronecker product of the two DFT matrices. This is the simplest way to obtain a set of basis vectors using only the dimension of the sub-arrays without using any cell specific or UE specific information.

Rotated DFT: The basis vectors for this case are generated by obtaining the normal DFT vectors and then using a specific rotation to the DFT vectors to direct the beam to the cell edge.

The basis vectors in this case are a function of the cell edge parameters, but are independent of the specific UE locations. Assume that the cell edge is given as d, then the corresponding rotation that must be applied is given as:

$${θ}_{m} = 180 ° - {tan}^{- 1} \frac{d}{{b}_{h} - {u}_{h}}$$

where bₕ and uₕ are the base station height and the UE height respectively.

The corresponding rotation vector is given as:

$${D}_{i} = {e}^{j \frac{2 π}{λ} {d}_{n} cos {θ}_{m} + j \frac{2 π}{N} ni} , n = 0 … N - 1$$

where dₙ is the antenna spacing between the antenna elements in the vertical dimension, and θₘ is the angle of rotation for the beam to rotate in the direction of the cell edge. Let Vᵢ be the DFT matrix in the elevation dimension and Lᵢ be the DFT matrix in the horizontal dimension. Then the final DFT matrix is obtained as kron(Lᵢ, DᵢVᵢ), where kron( ) is the Kronecker product.

Best Single Beam, “Cell Specific”: It is single best beam in the DFT basis that is obtained by rotating the normal DFT with different angles and comparing the performance (coupling loss) over the LOS channel corresponding to users uniformly dropped in the cell.

In some embodiments, a series of channel measurements are generated assuming a uniform UE dropping over a cell area of given cell radius and a LOS channel path. The channels thus generated are used to obtain the channel estimate with DFT basis with different rotations.

The coupling loss is used as a performance metric for all UEs, and can be given as:

$${C}_{i} = \frac{\vert {\hat{h}}^{H} h \vert}{‖ \hat{h} ‖}$$

The θ is chosen such that the coupling loss is minimum.

Eigen Value Decomposition (EVD): Instead of using DFT vectors as the basis vectors, the eigen vectors of the covariance matrix of the channel can be used, and this would give the vector that has the maximum weight for the set of channels being considered.

The eigen vectors are obtained as the following:

$$[ E , λ ] = eig ( 𝔼 [ {h}_{1 : {N}_{A}} {h}_{1 : {N}_{A}}^{H} ] )$$

where E, λ are the eigen vectors and eigen values respectively, and h_{1:N}_{_{A}}, is the LOS channel corresponding to a uniform UE dropping. The phase of the eigen vectors are chosen as the vectors. The final basis vectors are given as angle (E).

Modified Eigen Value Decomposition (mod-EVD): The suboptimality in the method which uses EVD to find the basis vectors is the phase extraction operation. The vectors that are obtained using EVD might not be linearly independent or pointing in the desired direction. In this case, repeated EVD can be used on the error and to obtain the vectors.

For example, the following can be used to obtain T basis vectors, for each step T

$$E = eig ( 𝔼 [ {h}_{1 : {N}_{A}} {h}_{1 : {N}_{A}}^{H} ] ) \\ p = exp ( i ∠ E ) \\ h = h - \frac{( {h}^{H} p )}{{‖ p ‖}^{2}} p$$

Then concatenate p to the set of basis vectors.

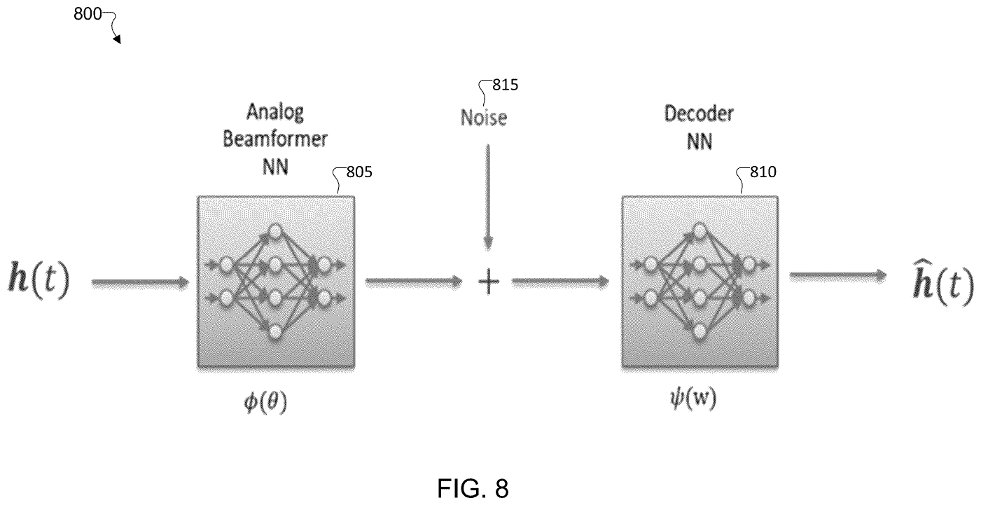

Basis vectors using AI/ML: In some embodiments, neural networks can be used to determine the analog beamformer to receive the uplink channel estimation as well as the decoder to obtain the channel estimate from the received signal. FIG. 8 illustrates a structure of a neural network 800 according to various embodiments of the present disclosure. The neural network 800 can be used, for example, for analog beamforming and decoding for receiving the uplink SRS. The embodiment of the neural network 800 is for illustration only. Other embodiments of the neural network 800 could be used without departing from the scope of this disclosure.

As shown in FIG. 8, the neural network 800 includes multiple network blocks that are trained simultaneously. The network blocks include an analog beamformer network 805 trained to apply a phase rotation to a channel, and a decoder network 810 trained to receive the phase-rotated channel and noise 815 as input and generate an estimated channel.

The analog beamformer network 805, represented as ϕ(θ), takes the channel as the input and applies a phase rotation to the elements of the channel to mimic the phase shifter of the analog beamformer. Each element of the channel h(t) is multiplied with a phasor e^{jθ} where θ represents the parameters of the neural network that are learned using backpropagation. The dimension of the θ parameter depends on the size of the sub-array. The values obtained after the phase rotation are linearly combined to obtain the projections α. The noise 815 is added to the projections α to get \hat{α}, which are fed as input to the decoder network 810. The decoder network 810 has the estimated channel as the output. The decoder network 810 can be a deep learning network with a series of hidden layers represented as ψ(w), where w are the parameters that are learned. The loss function can be the cosine similarity between the input h and the output ĥ to train the parameter of both the analog beamformer network 805 and the decoder network 810.

### Ordering of the Basis Vectors.

In the previous section, techniques were described for formulating a set of basis vectors. However, it was not specified which of those beams have higher weights than others. In other words, if it is necessary to choose a limited number of beams from the full set, which of those beams should be prioritized over others.

In some embodiments, the basis vectors are ordered such that the basis vectors with low priority could be ignored if there is a limitation on the complexity of the channel measurement and estimation. A couple of different options will now be provided.

In one option, common ordering of the basis vectors could be adopted across users. The common ordering assumes the same order for selecting beams irrespective of the UE locations. This order can be selected manually or by using the mean cosine similarity for a set of uniform user locations and LOS channel assumptions.

In another option, UE specific ordering could be adopted. As discussed above, a set of basis vectors or beams can be generated and used for acquiring channel knowledge from the users. However, the location of UE is random, and a beam vector that works for one user's channel might not be effective for another user. Therefore, the set of beam vectors can be ordered such that each UE has the appropriate beams pointing towards it for acquiring the SRS signal.

In the UE specific ordering, the channel information of the UEs can be used to determine the SRS beams to be used. This information can be acquired using different techniques like the SSB beams that are used for initial access. Such choice of beams for users is used when there is scope for single user MIMO or the ability to group the users based on which of them have the same beam. Once the channel information is known, the beams can be ordered using the cosine similarity that is obtained for each user by assuming one of the single beam.

Assume there are the beams, pⱼ, j=1:T, i.e., T beams that can be used for the user. For each user i, compute the cosine similarity when each of the pⱼ beams are used for channel estimation, given as the following:

$${CS}_{ij} = \frac{\vert {\hat{h}}_{i}^{H} ( {p}_{j} ) {h}_{i} \vert}{‖ {\hat{h}}_{i} ( {p}_{j} ) ‖ ‖ {h}_{i} ‖} ,$$

where ĥᵢ(pⱼ) is the channel estimate using pⱼ as the SRS beam. Thus:

p*=argmaxⱼCSᵢⱼ.

This optimization can be repeated for each user to determine the best SRS beam for each user.

### Analog and Digital Precoding.

In a MU-MIMO system, the BS can generate an analog precoding matrix for hybrid analog-digital MIMO precoding. Techniques for generating the analog precoding matrix will now be described.

In some embodiments, the analog precoding matrix is generated such that analog precoding is common across all digital sub-arrays of the antenna panel. The analog precoding could be made the same across the digital sub-arrays if the digital sub-arrays have the same aperture and directions. In a case where all the sub-arrays have the same aperture and boresight direction, the nonzero elements of F_{RF} is the same across the columns as shown below,

$${F}_{RF} = [ \begin{matrix}{f}_{RF , i} & 0 & … & 0 \\ 0 & {f}_{RF , i} & … & 0 \\ ⋮ & ⋮ & ⋱ & 0 \\ 0 & 0 & … & {f}_{RF , i}\end{matrix} ] ,$$

where f_{RF,i}∈ [symbol] ^{N}^{_{Ant}}^{^{SA}}^{×1} is the analog precoding and N_{Ant}^{SA} is the number of antennas in a sub-array.

In some embodiments, the analog precoding matrix is generated according to the phase of the maximum eigenvector of the channel correlation matrix of the first sub-array. Because of the unit-norm constraint of the analog precoder, the maximum eigenvector cannot be directly adopted. Instead, the BS chooses to only keep the phase of the maximum eigenvector and normalize the amplitude. Let H_{i,j,k} be the channel for the i^{th} UE, the j^{th} subband, and k^{th} digital sub-array. Then the analog precoder can be given by the following:

$${f}_{RF , i} = exp ( j ∠ arg {max}_{f} ( {\sum }_{i , j} {f}^{H} {H}_{i , j , 1}^{H} {H}_{i , j , 1} f ) )$$

where ∠f is the phase of the complex-valued vector f. Alternatively, the common vector is determined by a phase of the maximum eigenvector of the average channel correlation matrix of a subset of sub-arrays.

In some embodiments, the analog precoding matrix is designed by an iterative algorithm as follows. Denote M=Σ_{i,j}H_{i,j,1}^{H}H_{i,j,1}. Here, the analog beamforming weights are of a unit magnitude, and initialized by taking a uniform distribution across phase values. Then update each element of the analog precoder sequentially according to the following equation:

$${a}_{i} ← exp ( j ∠ ( {\sum }_{k \neq i} {M}_{ik} {a}_{k} ) )$$

where αᵢ is the i-th entry of the analog precoder.

For the digital precoding, the ZF or regularized ZF precoding is applied. If there are only a few UEs, and there are multiple digital ports, the maximum ratio transmission (which has lower complexity than ZF and RZF) could be applied.

In some embodiments, the analog precoding matrix is designed according to the long-term channel state information (for example, the second-order statistics), while the digital precoding is generated based on the instantaneous knowledge of the channel state information.

### Joint UE Scheduling and Precoding Design.

Before the BS communicates with the multiple users, the BS schedules the users. For a hybrid precoding architecture, a separate scheduler and precoder design could degrade the end-to-end performance. Accordingly, techniques can be used in which a BS jointly determines the MU-MIMO precoding matrix and schedules users for a hybrid analog-digital MIMO precoding system.

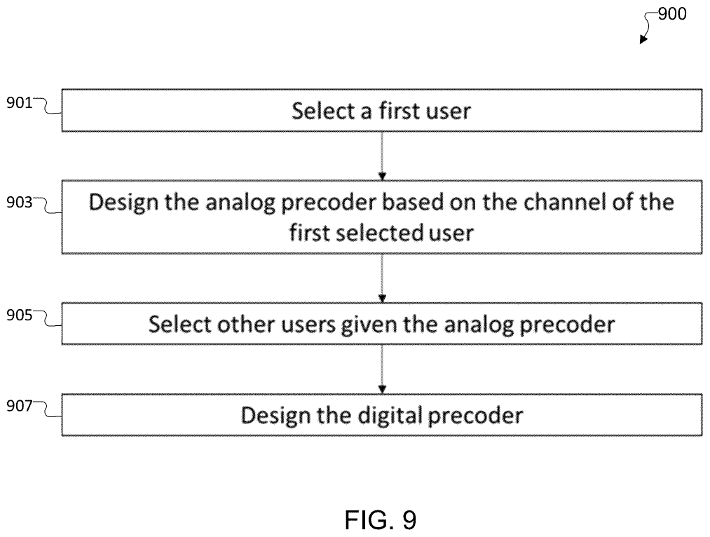

FIG. 9 illustrates an example process 900 for joint selection and precoding design according to various embodiments of the present disclosure. The embodiment of the process 900 is for illustration only. Other embodiments of the process 900 could be used without departing from the scope of this disclosure.

As shown in FIG. 9, at step 901, the BS selects a first user. At step 903, the BS generates the analog precoding matrix based on the channel of the selected first user, and then projects the channel on the analog precoding. At step 905, the BS selects the other users based on the analog precoding matrix, and at step 907, the BS designs the digital precoder.

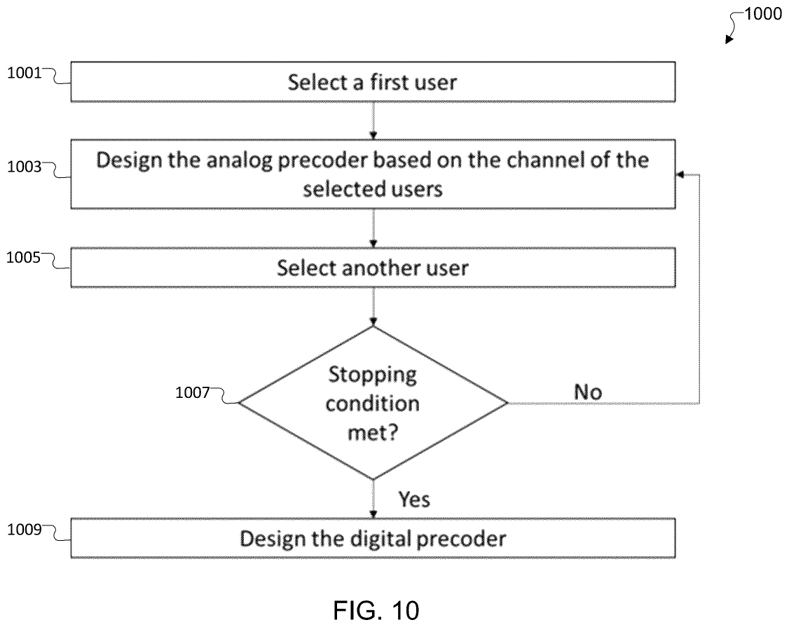

FIG. 10 illustrates another example process 1000 for joint selection and precoding design according to various embodiments of the present disclosure. In the process 1000, the BS alternatively performs the UE selection and the precoder design. The embodiment of the process 1000 is for illustration only. Other embodiments of the process 1000 could be used without departing from the scope of this disclosure.

As shown in FIG. 10, at step 1001, the BS selects a first user. At step 1003, the BS generates the analog precoding matrix based on a channel of the first user. At step 1005, the BS selects another user, and at step 1007, the BS determines if a stopping condition is met. If the stopping condition is not met, then the BS returns to step 1003 and updates the analog precoding matrix based on all selected users. This is repeated until the stopping condition is met at step 1007. At step 1009, in response to the stopping condition being met, the BS designs the digital precoder.

The stopping condition in step 1007 could be, for example: (i) a certain number of users are selected (for example, 8 users or 16 users), (ii) the total throughput does not increase if another user is selected, or (iii) there is no other user with buffered traffic. Of course, other stopping conditions are possible and within the scope of this disclosure.

Although FIGS. 5 through 10 illustrate various techniques and details related to channel estimation, hybrid precoding, and scheduling in a multi-user MIMO system, various changes may be made to FIGS. 5 through 10. For example, various components in FIGS. 5 through 10 could be combined, further subdivided, or omitted and additional components could be added according to particular needs. In addition, various operations in FIGS. 5 through 10 could overlap, occur in parallel, occur in a different order, or occur any number of times.

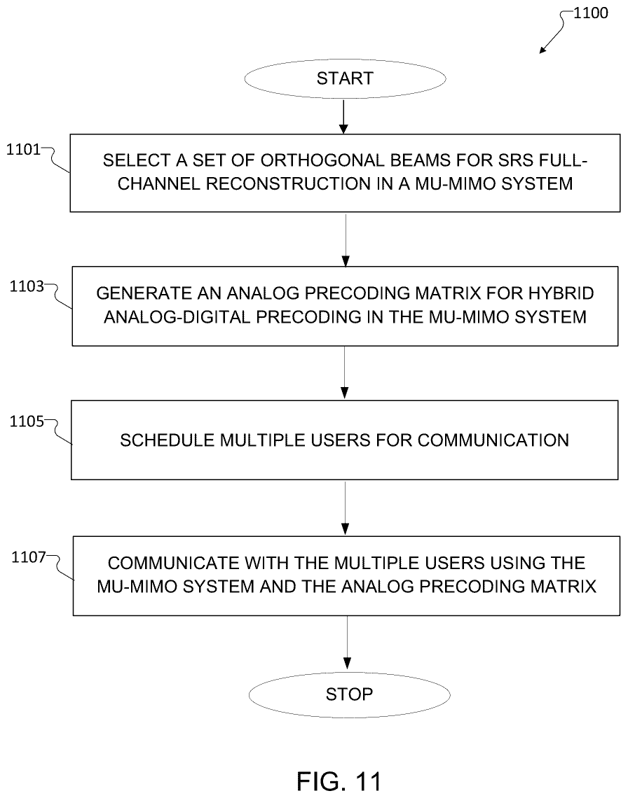

FIG. 11 illustrates a method 1100 for channel estimation, hybrid precoding, and scheduling in a multi-user MIMO system according to embodiments of the present disclosure, as may be performed by one or more components of the network 100 (e.g., the BS 102). The embodiment of the method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As illustrated in FIG. 11, the method 1100 begins at step 1101. At step 1101, a BS selects a set of orthogonal beams to be used for SRS full-channel reconstruction in a MU-MIMO system. This could include, for example, the BS 102 selecting the orthogonal beams using one or more of the techniques described above, such as a rotated discrete Fourier transform, a best single beam technique, eigen value decomposition, modified eigen value decomposition, or using a trained neural network.

At step 1103, the BS generates an analog precoding matrix for hybrid analog-digital precoding in the MU-MIMO system. This could include, for example, the BS 102 generating the analog precoding matrix using one or more of the techniques described above, such as generating the analog precoding matrix such that analog precoding is common across all sub-arrays of an antenna panel, generating the analog precoding matrix according to a phase of a maximum eigenvector of a channel correlation matrix of a first sub-array, or generating the analog precoding matrix using an iterative algorithm.

At step 1105, the BS schedules multiple users for communication. This could include, for example, the BS 102 scheduling the UEs 111-116 for communication.

At step 1107, the BS communicates with the multiple users using the MU-MIMO system and the analog precoding matrix. This could include, for example, the BS 102 communicating with the UEs 111-116 using MU-MIMO.

Although FIG. 11 illustrates one example of a method 1100 for channel estimation, hybrid precoding, and scheduling in a multi-user MIMO system, various changes may be made to FIG. 11. For example, while shown as a series of steps, various steps in FIG. 11 could overlap, occur in parallel, occur in a different order, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
selecting a set of orthogonal beams to be used for SRS full-channel reconstruction in a multi-user multiple-input multiple-output (MU-MIMO) system;
generating an analog precoding matrix for hybrid analog-digital precoding in the MU-MIMO system; and
communicating with multiple users using the MU-MIMO system and the analog precoding matrix.

2. The method of claim 1, wherein the set of orthogonal beams are selected using one of:
a rotated discrete Fourier transform;
a best single beam technique;
eigen value decomposition; or
modified eigen value decomposition.

3. The method of claim 1, wherein the set of set of orthogonal beams are selected using a trained neural network that includes (i) an analog beamformer network trained to apply a phase rotation to a channel, and (ii) a decoder network trained to receive the phase-rotated channel and a noise input and generate an estimated channel.

4. The method of claim 1, wherein generating the analog precoding matrix comprises one of:
generating the analog precoding matrix such that analog precoding is common across all sub-arrays of an antenna panel;
generating the analog precoding matrix according to a phase of a maximum eigenvector of a channel correlation matrix of a first sub-array; or
generating the analog precoding matrix using an iterative algorithm.

5. The method of claim 1, further comprising:
scheduling the multiple users for communication.

6. The method of claim 5, wherein scheduling the multiple users for communication comprises:
selecting a first user, wherein the analog precoding matrix is generated based on a channel of the first user;
selecting other users based on the analog precoding matrix; and
designing a digital precoder after the other users are selected.

7. The method of claim 5, wherein scheduling the multiple users for communication comprises:
selecting a first user, wherein the analog precoding matrix is generated based on a channel of the first user;
repeatedly selecting another user and updating the analog precoding matrix based on all selected users until a stopping condition is met; and
in response to the stopping condition being met, designing a digital precoder.

8. A device comprising:
a transceiver; and
a processor operably connected to the transceiver, the processor configured to:
select a set of orthogonal beams to be used for SRS full-channel reconstruction in a multi-user multiple-input multiple-output (MU-MIMO) system;
generate an analog precoding matrix for hybrid analog-digital precoding in the MU-MIMO system; and
communicate with multiple users using the MU-MIMO system and the analog precoding matrix.

9. The device of claim 8, wherein the processor is configured to select the set of orthogonal beams using one of:
a rotated discrete Fourier transform;
a best single beam technique;
eigen value decomposition; or
modified eigen value decomposition.

10. The device of claim 8, wherein the processor is configured to select the set of orthogonal beams using a trained neural network that includes (i) an analog beamformer network trained to apply a phase rotation to a channel, and (ii) a decoder network trained to receive the phase-rotated channel and a noise input and generate an estimated channel.

11. The device of claim 8, wherein to generate the analog precoding matrix, the processor is configured to one of:
generate the analog precoding matrix such that analog precoding is common across all sub-arrays of an antenna panel;
generate the analog precoding matrix according to a phase of a maximum eigenvector of a channel correlation matrix of a first sub-array; or
generate the analog precoding matrix using an iterative algorithm.

12. The device of claim 8, wherein the processor is further configured to schedule the multiple users for communication.

13. The device of claim 12, wherein to schedule the multiple users for communication, the processor is configured to:
select a first user, wherein the analog precoding matrix is generated based on a channel of the first user;
select other users based on the analog precoding matrix; and
design a digital precoder after the other users are selected.

14. The device of claim 12, wherein to schedule the multiple users for communication, the processor is configured to:
select a first user, wherein the analog precoding matrix is generated based on a channel of the first user;
repeatedly select another user and update the analog precoding matrix based on all selected users until a stopping condition is met; and
in response to the stopping condition being met, design a digital precoder.

15. A non-transitory computer readable medium comprising program code that, when executed by a processor of a device, causes the device to:
select a set of orthogonal beams to be used for SRS full-channel reconstruction in a multi-user multiple-input multiple-output (MU-MIMO) system;
generate an analog precoding matrix for hybrid analog-digital precoding in the MU-MIMO system; and
communicate with multiple users using the MU-MIMO system and the analog precoding matrix.

16. The non-transitory computer readable medium of claim 15, wherein the program code causes the device to select the set of orthogonal beams using one of:
a rotated discrete Fourier transform;
a best single beam technique;
eigen value decomposition; or
modified eigen value decomposition.

17. The non-transitory computer readable medium of claim 15, wherein the program code causes the device to select the set of orthogonal beams using a trained neural network that includes (i) an analog beamformer network trained to apply a phase rotation to a channel, and (ii) a decoder network trained to receive the phase-rotated channel and a noise input and generate an estimated channel.

18. The non-transitory computer readable medium of claim 15, wherein the program code to generate the analog precoding matrix comprises program code to one of:
generate the analog precoding matrix such that analog precoding is common across all sub-arrays of an antenna panel;
generate the analog precoding matrix according to a phase of a maximum eigenvector of a channel correlation matrix of a first sub-array; or
generate the analog precoding matrix using an iterative algorithm.

19. The non-transitory computer readable medium of claim 15, wherein the program code further causes the device to schedule the multiple users for communication.

20. The non-transitory computer readable medium of claim 19, wherein the program code to schedule the multiple users for communication comprises program code to:
select a first user, wherein the analog precoding matrix is generated based on a channel of the first user;
select other users based on the analog precoding matrix; and
design a digital precoder after the other users are selected.
